(19) United States
(12) Patent Application Publication
(10) Pub. No.: US 2009/0028305 A1
(43) Pub. Date: Jan. 29, 2009

(54) TEMAIL

(76) Inventor: Riyaz Mohamed Shahul Hameed, Wheeling, IL (US)

Correspondence Address: RIYAZ MOHAMED SHAHUL HAMEED, 1671 WOOD DUCK LANE, #18, WHEELING, IL, 60090, US

(21) Appl. No.: 11/828,123

(22) Filed: Jul. 25, 2007

(51) Int. Cl. H04M 11/00; G06F 15/16

(52) U.S. Cl. 379/93.01; 709/206

(57) ABSTRACT

Telephonic Electronic mail is abbreviation of TEMAIL is a protocol/standard/tool/application for sending and receiving telephone audio messages in a secure and organized way.

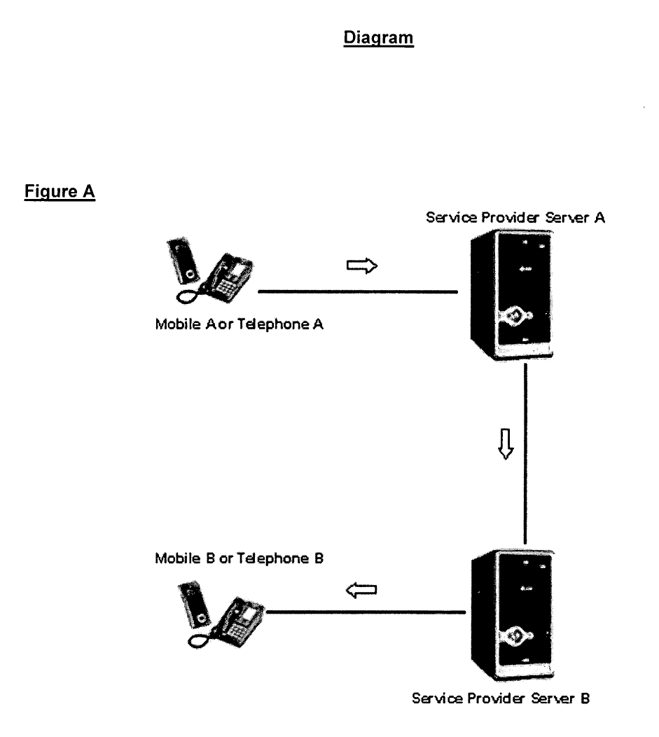

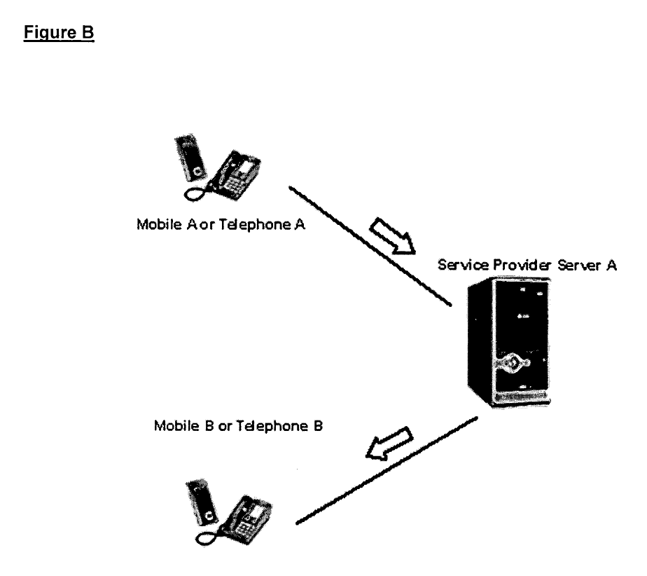

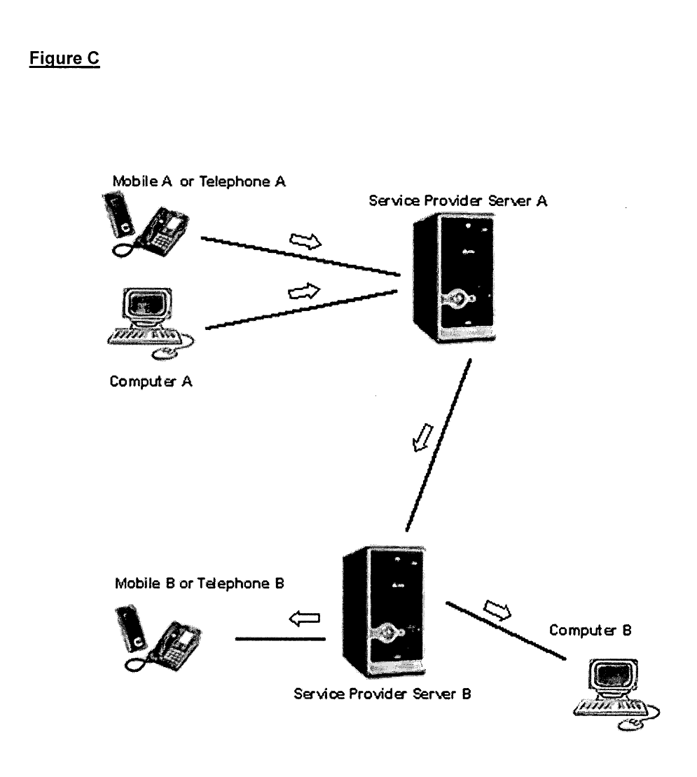

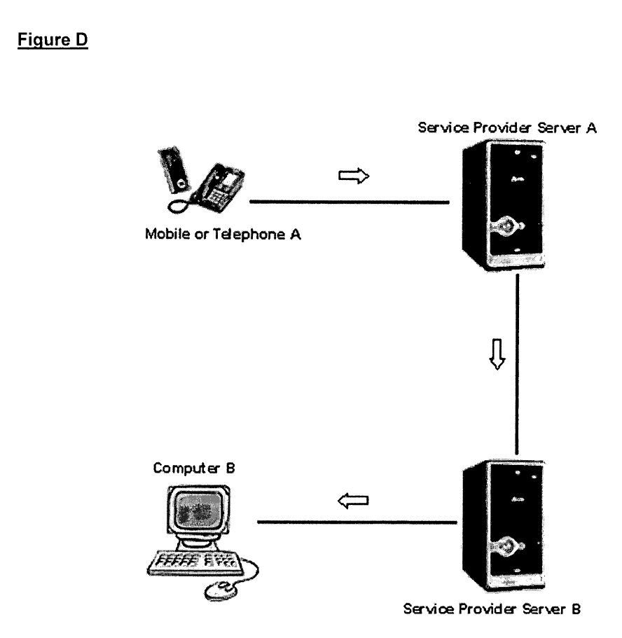

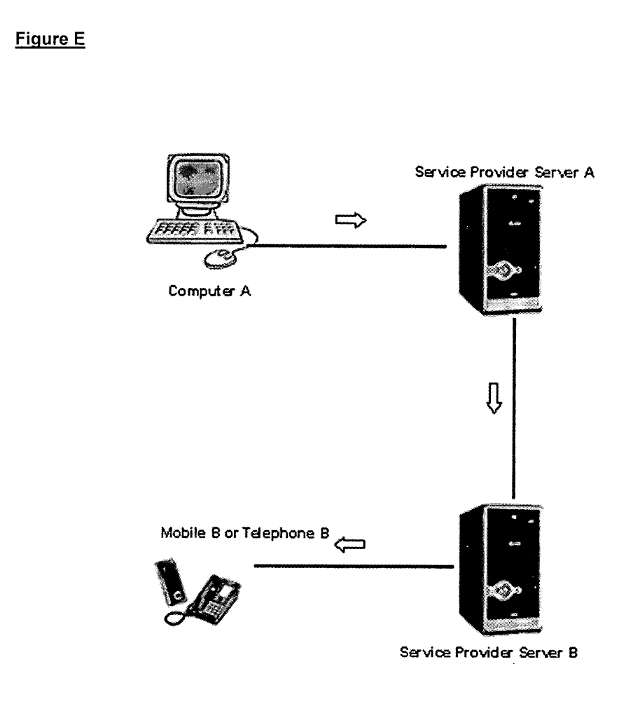

TEMAIL users require a telephone or a computer with Internet connection to send and receive audio electronic message.

TEMAIL users will not call the recipient number directly to deliver their audio message. Instead they specify recipient EMAIL ID or recipient TEMAIL ID and use TEMAIL service provider system to deliver the message to the recipient. This helps sender to deliver their messages to the recipients in any country and vise versa.

The following items are required for sending & receiving TEMAIL voice message.
1. Client A—Any mobile or basic phone (i.e.: —Landline) or any wireless device, which can act as client to send and receive audio messages.
2. Client B—Computer, which can act as client to send and receive any type of messages.
3. Server—This will store the message, sends, receive messages, convert text messages to audio messages (using voice converting software) and deliver the message to the recipients based on the mode in which it was requested.
   a. Store received message(s) from the sender server(s) or from the users(s)
   b. Send the message(s) to the recipient server(s) using internet/intranet protocol/telephone line.
   c. Notifies the recipient using Client A when the message is received.
   d. It delivers the audio message to the recipient when it's requested and or converts the text message to audio message and delivers to the recipient (Client A).
4. Internet/Intranet/telephone network or wireless network.

The provider of the TEMAIL service needs to implement/install TEMAIL in their server. They are called as Service Providers. They provide provision to their users to send and receive messages by providing a service-call-number (a toll free number). For example (1800REDFORTINC)

Users have to register with the Service providers' (who provides TEMAIL services) online application with the required registration information like phone number, name, user id & password, age and other information.

Each user is identified by unique user id they have provided to the Service provider or Service provider can assign a unique user id to each users.
For Example My user id is either one of the following: 18474201837riyaz or 184742018371 or riyaz.1.ect.
The above user id with service-call-number:
1800REDFORTINC#18474201837riyaz or 1800REDFORTINC#184742018371 (<service-call-number>#<my user id>. This number is called TEMAIL number/TEMAIL ID.
Note: the delimiter # symbol varies based on computer or operating system or based on provider standards & the service-call-number and user id can be interchanged based on the provider standards.
This process is similar to the email registration with the service provider and getting Email ID. For example if my service provider is REDFORTINC.com then I may get Rivaz.mohamed@redfortinc.com or rivaz1@redfortinc.com
<my emailed>@<service provider address>.
Note: if an email service provider has upgrade their system with this new addition TEMAIL functionality. Then their users can use the email id to access the message using telephone.

After successful completion of registration, user can send and receive messages to and from the register recipients using the TEMAIL service providers.

Users can send and receive their audio messages using telephone as well as computer. After successful authentication with their user id & password, users can choose any of the following option
Send audio/voice message,
Listen recorded message
Delete messages
Archive messages
Search the voice messages

### Send Audio Message Using Telephone or Mobile Phone

If user is using telephone as his/her client medium for sending the message then (s) he needs to follow following steps:
1. Call the service-call-number from the Mobile or basic (landline) phone.
2. After successful authentication, choose ‘Send a Message’ option.
3. Enter the recipient's service provider (service-call-number) # recipient user id (TEMAIL ID) or Email ID.
4. Record the subject with main & other audio messages.
5. Choose any of the below mentioned options:
   a. Save
   b. Send
   c. Rehear
   d. Modify
   e. Discard
6. By choosing the send option. The sender service provider store the message in the server and send the message to the recipient service provider using recipient TEMAIL ID (using recipient service-call-number) or recipient Email ID.
7. The recipient, service provider sends a notification to the recipient user about the new message using recipient registered phone number and user id mentioned in the TEMAIL ID. If recipient service provider is same as sender then it will directly send the notification to the recipient user. Without finding the recipient service provider.
8. To make the message delivery as secured. The following handshaking step will be followed.
   a. From the user calling phone the sender service provider get the calling phone number, time and user id who is calling to deliver the message.
   b. It sends the received user information to the recipient server for log and security purpose, along with the message.
   c. If the recipient service-call-number or the recipient number is not available the sender service provider maintains the status as not deliver because of such reason.
   d. If the recipient service-call-number or the recipient number is engaged the sender and the recipient will try to redeliver the message.
   e. Based on each scenario and sender service provider and recipient service provider maintains status messages respectively.
   f. If the receiver has an email ID with server IP the message will be delivers to the email server as attached audio message.
   g. If the sender send a message to a recipient using recipient service-call-number and user id. Then the sender server finds the IP of the recipient server first using the service-call-number and delivers the message to the recipient server using the IP (as email delivery).

### Listen Audio Message Using Telephone or Mobile Phone

1. User need to call the service-call-number and after successful authentication. User can choose the option to listen the received message.
2. By choosing the received message option, user can listen to the received audio message. If they have received the message as a text, then the server converts the text message to audio message using voice converter and delivers the message.

### Send Audio Message Using Computer

If user is using Computer as his/her client medium for sending the message then (s) he needs to follow following steps:
1. Login to the service provider TEMAIL/Email application
2. After successful authentication, go to audio message inbox page.
3. Using audio compose menu, record the message or type a regular text message.
4. Enter the recipient service-call-number# register user Id (TEMAIL ID)/Email ID in the address(s) of the message.
5. Click on the send message and the message will be delivered to the respective person service provider server for delivery.

### Send Audio Message Using Telephone or Mobile Phone & Computer

If user is using telephone & computer as his/her client medium for sending the message then (s) he need to follow following step,
1. Call the service-call-number from the Mobile or basic (landline) phone.
2. After successful authentication. Choose ‘Record a Message’ option.
3. Record the subject with main & other audio messages.
4. At latter point of time the users uses the computer to send the recorded message to the recipient(s).

### Listen Audio Message Using Computer

1. Login to the service provider.
2. After successful authentication, go to his audio message inbox.
3. This will have list of all the received messages. By clicking on the specific message user can listen the received message.

### The Key Benefits of TEMAIL

1. There is no requirement for computer for sending and receiving the message between registered users.
2. User will not call the recipient number directly to deliver their audio message. Instead registered user's uses TEMAIL service provider system to deliver the message to the recipient using recipient Email ID or TEMAIL ID. This helps sender to deliver their messages to the recipients in any country and vise versa.
3. User can view the status of message. Following can be the different status of a message
   Listened
   Not Listened
   Deleted
4. User can send and receive message to any service provider in any country. To send and receive message across different country/service provider, user need to use following pattern, while sending or receiving message
   <Receiver service-call-number>#<Receiver user id>.
   For example: 18004201837#18474201837.1 or 18004201837#18474201837.riyaz or 18004201837#riyaz (TEMAIL ID) or Email ID
5. TEMAIL can be used for any business or personal purposes.
   For example: In customer service call, User need not have to wait in the queue to deliver their message to the customer service representative and vise versa. He doesn't have to call the direct customer service phone number. Using customer service TEMAIL ID/Email ID user delivers the audio message to the customer service office/system using their telephone. After hearing the message the customer service return the message back to the users using the user's TEMAIL ID/Email ID. This is one of the business purposes for which TEMAIL can be used.
6. User can view the recorded, received and sent audio messages using telephone and computer using the service provider online TEMAIL application.
7. The different statuses of the messages can be tracked easily.
8. Its 100% secure and guaranteed deliver.
9. Recipient can hear their voice/audio message using any phone or computers.
10. User can listen to their email text messages using telephone/phone. The email text messages will be converted to audio messages using voice converter software and deliver to the recipient.

Figure A (Refer Diagram)

### Mobile A or Telephone A=Sender

### Service Provider Server A=Sender Service Provider

### Service Provider Server B=Receiver Service Provider

### Mobile B or Telephone B=Receiver

Figure A: Shows that the user using telephone or mobile phone to deliver audio message to the receiver.
Sender calls the service provider's server using service call number.
Logs in to the application using his/her user id and password information
Records the message and specifies the receiver TEMAIL or EMAIL id to deliver the message.
The sender service provider receives the message and stores the message in the server,
The sender service provider server identifies the recipient server using TEMAIL or EMAIL id and sends the audio message to the recipient server provider server.
The recipient service provider sends a notification to the recipient users about the new message using recipient registered phone number.
Latter recipient can here the message any time from the recipient service provider using his/her user id and password information.

Listen Audio Message Using Telephone or Mobile
User need to call the service-call-number and after successful authentication. User can choose the option to listen the received message.
By choosing the received message option, user can listen to the received audio message. If they have received the message as a text, then the server converts the text message to audio message using voice converter and delivers the message.

Figure B (Refer Diagram)

### Mobile A or Telephone A=Sender

### Service Provider Server A=Sender & Receiver Service Provider

### Mobile B or Telephone B=Receiver

Figure B: Shows that the user using telephone or mobile phone to deliver audio message to the receiver. In this case the sender and the receiver same service provider are same.
Sender calls the service provider's server using service call number.
Logs in to the application using his/her user id and password information
Records the message and specifies the receiver TEMAIL or EMAIL id to deliver the message.
The sender service provider receives the message and stores the message in the server,
Since the recipient service provider is same as sender then it will directly send the notification to the recipient users about the new message using recipient registered phone number.
Latter recipient can here the message any time from the recipient service provider using his/her user id and password information.

Refer Figure A description for receiver using telephone or mobile phone to hear the received messages.

Figure C (Refer Diagram)

### Mobile A or Telephone A and or Computer A=Sender

### Service Provider Server A=Sender Service Provider

### Service Provider Server B=Receiver Service Provider

### Mobile B or Telephone B and or Computer B=Receiver

Figure C:

Refer Figure A & B description for sender using telephone or mobile phone to deliver the message.

Refer Figure A description for receiver using telephone or mobile phone to hear the received messages.

Sender Using Computer to Deliver the Message.

If user is using Computer as his/her client medium for sending the message then (s) he needs to follow following steps:
Login to the service provider TEMAIL/Email application using computer.
After successful authentication, go to audio message inbox page.
Using audio compose menu, record the message or type a regular text message.
Enter the recipient service-call-number# register user (TEMAIL ID)/Email ID in the address(s) of the message.
Click on the send message and the message will be delivered to the respective person service provider server for delivery.

Sender Using Telephone and Computer to Deliver the Message.

If user is using telephone & computer as his/her client medium for sending the message then (s) he need to follow following step,
Call the service-call-number from the Mobile or basic (landline) phone.
After successful authentication. Choose ‘Record a Message’ option.
Record the subject with main & other audio messages.
At latter point of time the users uses the computer to send the recorded message to the recipient(s).

Listen Audio Message Using Computer
Login to the service provider using computer.
After successful authentication, go to his audio message inbox.
This will have list of all the received audio messages. By clicking on the specific message user can listen the received message.

Figure D (Refer Diagram)

### Mobile A or Telephone A and or Computer A=Sender

### Service Provider Server A=Sender Service Provider

### Service Provider Server B=Receiver Service Provider

### Computer B=Receiver

Refer Figure A & B description for sender using telephone or mobile phone to deliver the message.
Refer Figure C description for receiver using computer to hear the received message.

### Figure E (Refer Diagram)

### Computer A=Sender

### Service Provider Server A=Sender Service Provider

### Service Provider Server B=Receiver Service Provider

### Mobile B or Telephone B=Sender

Refer Figure C description for sender using computer to deliver the message.
Refer Figure A description for receiver using telephone or mobile phone to hear the received messages.

1. In this message deliver system user does not have to call the direct phone or mobile number to deliver the message. Instead they can use the TEMAIL ID or EMAIL ID to deliver the audio or text message using the TEMAIL service providers. The TEMAIL service provider then transcript to its all recipient clients (receivers).

2. Email user can use computer and send audio/text message to the TEMAIL users. If a TEMAIL telephone user receives any text email messages, then the server converts the text message to audio message using voice converter and delivers the message to the telephone users.

3. TEMAIL user can send audio messages to EMAIL Users they have an option during their call to convert the audio message to text message delivery to the EMAIL users.
